(19) United States
(12) Patent Application Publication
(10) Pub. No.: US 2010/0238952 A1
(43) Pub. Date: Sep. 23, 2010

(54) BROADBAND NETWORK TERMINAL AND METHOD FOR DYNAMICALLY ALLOCATING NETWORK ACCESS RESOURCES

(75) Inventor: HUA-JUI PENG, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/425,400

(22) Filed: Apr. 17, 2009

(30) Foreign Application Priority Data
Mar. 20, 2009 (CN) 200910300985.9

(51) Int. Cl. H04L 12/26

(52) U.S. Cl. 370/468

(57) ABSTRACT

A broadband network terminal receives user connection requests, and calculates an average value of network access resources according to original users and at least one newly-added user. The broadband network terminal determines whether the network access resources utilized by each original user exceed the average value, determines whether the network access resources are unavailable when the network access resources utilized by at least one original user exceed the average value, and releases network access resources utilized by the at least one original user that exceed the average value when the network access resources are unavailable. The broadband network terminal then allocates average network access resources to the newly-added user.

### BACKGROUND

1. Technical Field

The present disclosure relates to network communications, and more particularly to a broadband network terminal and a method for dynamically allocating network access resources of the broadband network terminal.

2. Description of Related Art

Due to rapid developments in the Internet technology, hosts using Internet protocol (IP) addresses have increased dramatically, resulting in a lack of available IP addresses. Accordingly, network address translation (NAT) has been introduced to resolve the problem.

Under NAT management, one broadband network line can simultaneously provide Internet service for a plurality of users. However, with the development of network technologies, client-server models for file transfer have been replaced with peer to peer (P2P) software-based systems, with network access resources increasing commensurately.

Thus, a problem arises in which network access resources can be largely occupied by a single user of the P2P software, such that other users cannot access Internet service. For example, FIG. 5 shows a user 1 using the P2P software occupying the majority of network access resources, such that the user 3 has his/her connection request to the Internet rejected.

### BRIEF DESCRIPTION OF THE DRAWINGS

Many aspects of the embodiments can be better understood with references to the following drawings.

FIG. 1 is a schematic diagram of functional modules of one embodiment of a broadband network terminal in accordance with the present disclosure;

FIGS. 2-3 are schematic diagrams showing a broadband network terminal dynamically allocating network access resources in accordance with the present disclosure;

FIG. 4 is a flowchart of one embodiment of a method for dynamically allocating network access resources in accordance with the present disclosure; and

FIG. 5 is a schematic diagram showing network access resources being occupied by a user and other users not obtaining the Internet service.

### DETAILED DESCRIPTION

All of the processes described may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

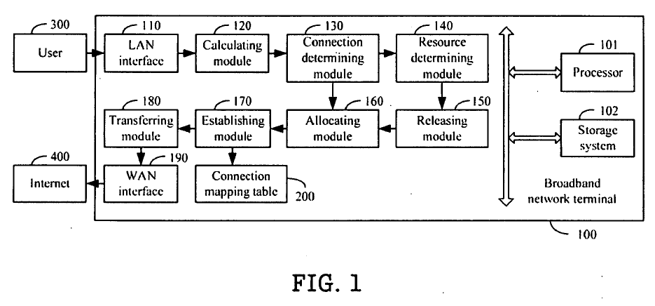

FIG. 1 is a schematic diagram of functional modules of one embodiment of a broadband network terminal 100 in accordance with the present disclosure. In one embodiment, the broadband network terminal 100 is connected between a plurality of users 300 and the Internet 400, and is operable to provide network access service to the plurality of users 300. That is, the broadband network terminal 100 transfers Internet connection packets from the plurality of users 300 to the Internet 400. The broadband network terminal 100 may be a network address translation (NAT), a firewall, an Internet protocol (IP) sharing device, or another device translating IP addresses.

In one embodiment, the broadband network terminal 100 dynamically allocates network access resources of the broadband network terminal 100 to the plurality of users 300. For example, if the network access resources are largely occupied by one user, with other users 300 unable access sufficient network access resources, the broadband network terminal 100 is operable to allocate the network access resources equally among all the users 300. In the disclosure, the network access resources include available network connections.

The broadband network terminal 100 includes a calculating module 120, a connection determining module 130, a resource determining module 140, a releasing module 150, an allocating module 160, at least one processor 101, and a storage system 102. The modules 120-160 may comprise one or more computerized instructions that are stored in the storage system 102 and are executed by the at least one processor 101.

The calculating module 120 is operable to receive user connection requests from the plurality of users 300. The calculating module 120 is further operable to calculate an average value of the network access resources according to a total number of original users and at least one newly-added user from the plurality of users 300. In one embodiment, the user connection requests are operable to request connection to the Internet 400.

The connection determining module 130 is operable to determine whether the network access resources utilized by each original user exceed the average value.

The resource determining module 140 is operable to determine whether network access resources are unavailable upon the condition that the network access resources utilized by the at least one original user exceed the average value.

The releasing module 150 is operable to release network access resources utilized by the at least one original user that exceed the average value upon the condition that the network access resources are unavailable. Accordingly, the allocating module 150 is operable to allocate average network access resources to the newly-added user.

The allocating module 150 is further operable to allocate remaining network access resources to the newly-added user upon the condition that the network access resources utilized by each original user do not exceed the average value. The allocating module 150 is further operable to allocate remaining network access resources to the newly-added user upon the condition that the network access resources are available.

The broadband network terminal 100 may further include a local area network (LAN) interface 110, an establishing module 170, a transferring module 180, a wide area network (WAN) interface 190, and a connection mapping table 200.

The LAN interface 110 is operable to receive the user connection requests, and transmit the user connection requests to the calculating module 120. The establishing module 170 is operable to establish a connection entry for the newly-added user. The connection mapping table 200 is operable to store the connection entry of the newly-added user. In one embodiment, the connection entry of the newly-added user includes a mapping between a LAN IP address and a public IP address of the newly-added user.

The transferred module 180 is operable to transform the LAN IP address to the public IP address of the newly-added user according to the connection entry of the newly-added user, and transfer a connection packet of the newly-added user to the Internet 400 according to the public IP address of the newly-added user.

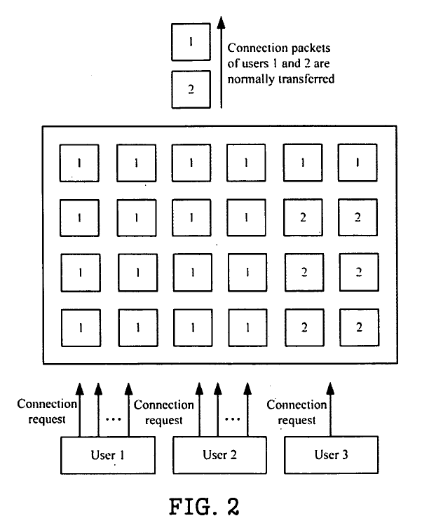

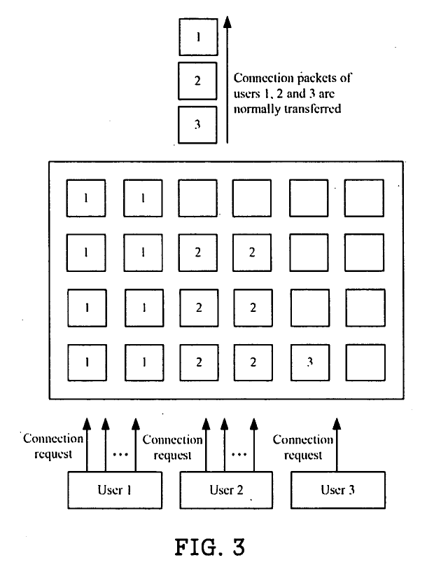

FIGS. 2-3 are schematic diagrams showing the broadband network terminal 100 of FIG. 1 dynamically allocating network access resources in accordance with the present disclosure. In this example, a user 1 and a user 2 initially send connection requests to the broadband network terminal 100, where the broadband network terminal 100 allocates the network access resources to the user 1 and the user 2, and transfers connection packets from the users 1 and 2 to the Internet 400. In one example, the user 1 is using a peer to peer (P2P) software, which occupies most of the network access resources. The user 2 is using a software other than the PSP software, such as a hyper text transfer protocol (HTTP) software, which occupies only a small portion of the network access resources.

Subsequently, at least one newly-added user 3 sends a connection request to the broadband network terminal 100, but no network access resources remain, having been previously occupied by the user 1.

Accordingly, the broadband network terminal 100 calculates an average value of the network access resources according to the total number of the original users (the users 1 and 2) plus the newly-added user 3, determines whether the network access resources utilized by each of the users 1 and 2 exceed the average value, and determines whether the network access resources are unavailable. As shown in FIG. 2, the calculations shows that the network access resources utilized by the user 1 greatly exceed the average value, the network access resources utilized by the user 2 do not exceed the average value, and no network access resources are available for the newly-added user 3.

Referring to FIG. 3, the broadband network terminal 100 correspondingly releases the network access resources utilized by the user 1 that exceed the average value, and allocates the network access resources equaling the average value to the user 2 and the newly-added user 3.

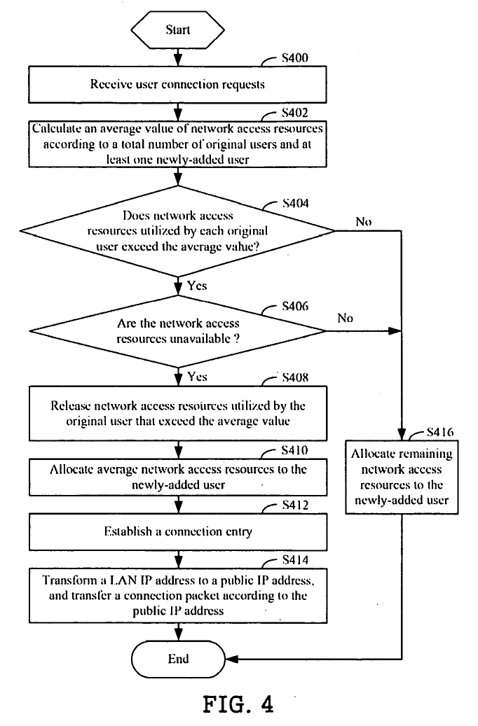

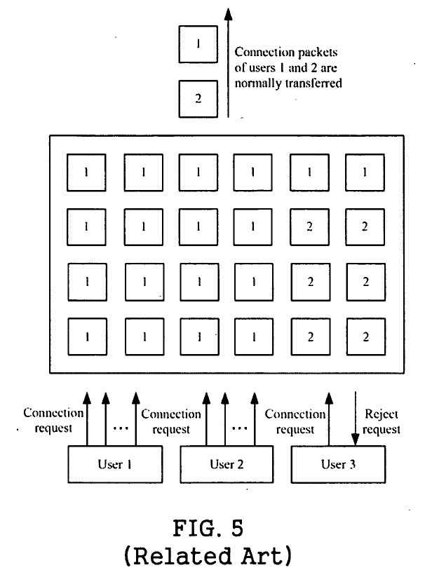

FIG. 4 is a flowchart of one embodiment of a method for dynamically allocating network access resources in accordance with the present disclosure. The method may be embodied in the broadband network terminal 100, and is executed by the functional modules such as those of FIG. 1. Depending on the embodiment, additional blocks may be added, others deleted, and the ordering of the blocks may be changed while remaining well within the scope of the disclosure.

In block S400, the calculating module 120 receives user connection requests. In one embodiment, connection to the Internet 400 is requested. The calculating module 120 receives the user connection requests via the LAN interface 110.

In block S402, the calculating module 120 calculates an average value of the network access resources according to a total number of original users and at least one newly-added user.

In block S404, the connection determining module 130 determines whether network access resources utilized by each original user exceed the average value.

If the network access resources utilized by each original user do not exceed the average value, the allocating module 160 allocates remaining network access resources to the newly-added user as described in block S416.

If the network access resources utilized by at least one original user exceed the average value, the resource determining module 140 determines whether network access resources are unavailable as described in block S406.

If the network access resources are available, the allocating module 160 allocates remaining network access resources to the newly-added user as described in block S416.

If the network access resources are unavailable, the releasing module 150 releases the network access resources utilized by the at least one original user that exceed the average value as described in block S408.

In block S410, the allocating module 160 allocates average network access resources to the newly-added user.

In block S412, the establishing module 170 establishes a connection entry for the newly-added user. In one embodiment, the connection entry comprises a mapping relationship between a LAN IP address and a public IP address of the newly-added user.

In block S414, the transferring module 180 transforms the LAN IP address to the public IP address of the newly-added user according to the connection entry of the newly-added user, and transfers a connection packet of the newly-added user to the Internet 400 according to the public IP address of the newly-added user. In one embodiment, the transferring module 180 transfers the connection packet of the newly-added user to the Internet 400 via the WAN interface 190.

Thus, a broadband network terminal of the present disclosure dynamically allocates network access resources when mostly occupied by one user, providing other users with equal access.

While various embodiments and methods of the present disclosure have been described above, it should be understood that they have been presented by way of example only and not by way of limitation. Thus the breadth and scope of the present disclosure should not be limited by the above-described embodiments, but should be defined only in accordance with the following claims and their equivalents.

What is claimed is:

1. A broadband network terminal for dynamically allocating network access resources for a plurality of users, the broadband network terminal comprising a processor, a memory, and one or more programs, wherein the one or more programs are stored in the memory and operable to be executed by the processor, the programs comprising:
a calculating module operable to receive user connection requests, and calculate an average value of the network access resources according to a total number of original users and at least one newly-added user from the plurality of users;
a connection determining module operable to determine whether the network access resources utilized by each original user exceed the average value;
a resource determining module operable to determine whether the network access resources are unavailable upon the condition that the network access resources utilized by at least one original user exceed the average value;
a releasing module operable to release network access resources utilized by the at least one original user that exceed the average value upon the condition that the network access resources are unavailable; and
an allocating module operable to allocate average network access resources to the at least one newly-added user.

2. The broadband network terminal of claim 1, wherein the network access resources comprise network connections between the plurality of users and the Internet.

3. The broadband network terminal of claim 1, wherein the allocating module is further operable to allocate remaining network access resources to the at least one newly-added user upon the condition that the network access resources utilized by each original user do not exceed the average value, and operable to allocate remaining network access resources to the at least one newly-added user upon the condition that the network access resources are available.

4. The broadband network terminal of claim 1, further comprising a local area network (LAN) interface operable to receive the user connection requests, and transmit the user connection requests to the calculating module.

5. The broadband network terminal of claim 4, further comprising:
an establishing module operable to establish a connection entry for the at least one newly-added user, wherein the connection entry comprises a mapping relationship between a LAN Internet protocol (IP) address and a public IP address of the at least one newly-added user;
a connection mapping table operable to store the connection entry of the at least one newly-added user; and
a transferring module operable to transform the LAN IP address to the public IP address of the at least one newly-added user according to the connection entry of the at least one newly-added user, and transfer a connection packet of the at least one newly-added user to the Internet according to the public IP address.

6. The broadband network terminal of claim 5, further comprising a wide area network (WAN) interface operable to transfer the connection packet of the at least one newly-added user to the Internet.

7. A method for dynamically allocating network access resources in a broadband network terminal providing the network access service for a plurality of users, the method comprising:
receiving user connection requests, and calculating an average value of the network access resources according to a total number of original users and at least one newly-added user from the plurality of users;
determining whether the network access resources utilized by each original user exceed the average value;
determining whether the network access resources are unavailable if the network access resources utilized by at least one original user exceed the average value;
releasing the network access resources utilized by the at least one original user that exceed the average value if the network access resources are unavailable; and
allocating average network access resources to the at least one newly-added user.

8. The method of claim 7, wherein the network access resources comprise network connections between the plurality of users and the Internet.

9. The method of claim 7, further comprising:
allocating remaining network access resources to the at least one newly-added user if the network access resources utilized by each original user do not exceed the average value.

10. The method of claim 7, further comprising:
allocating remaining network access resources to the at least one newly-added user if the network access resources are available.

11. The method of claim 7, further comprising:
establishing a connection entry for the at least one newly-added user, wherein the connection entry comprises a mapping between a LAN Internet protocol (IP) address and a public IP address of the at least one newly-added user;
transforming the LAN IP address to the public IP address of the at least one newly-added user according to the connection entry; and
transferring a connection packet of the at least one newly-added user to the Internet according to the public IP address.
